(19) United States
(12) Patent Application Publication
(10) Pub. No.: US 2016/0162487 A1
(43) Pub. Date: Jun. 9, 2016

(54) SYSTEMS AND METHODS FOR RANKING AND PROVIDING RELATED CONTENT

(71) Applicant: Facebook, Inc., Menlo Park, CA (US)

(72) Inventors: Christopher Shahin Moghbel, Novato, CA (US); Varun Kacholia, Sunnyvale, CA (US); Yuanxuan Wang, San Carlos, CA (US); Deepa Diwakar, Mountain View, CA (US); David Vickrey, Mountain View, CA (US); Cameron Alexander Marlow, Menlo Park, CA (US)

(21) Appl. No.: 14/564,832

(22) Filed: Dec. 9, 2014

(51) Int. Cl. G06F 17/30; H04L 29/06; H04L 29/08

(52) U.S. Cl. CPC G06F 17/3053; G06F 17/30528; H04L 67/02; H04L 67/10; H04L 65/403; G06F 17/30867

(57) ABSTRACT

Systems, methods, and non-transitory computer-readable media can identify a source content item for which related content is to be provided. A set of candidate content items associated with the source content item can be selected. The set of candidate content items can be ranked based, at least in part, on a set of engagement signals associated with the set of candidate content items. A subset of highest ranked candidate content items out of the set of candidate content items can be provided as the related content for the source content item.

### FIELD OF THE INVENTION

The present technology relates to the field of providing content. More particularly, the present technology relates to techniques for ranking and providing related content.

### BACKGROUND

Today, people utilize computing devices (or systems) for various purposes. Users can use their computing devices to, for example, interact with one another, access content, share content, and create content. In some cases, a user of a social networking system (or service) can utilize his or her computing device to view, interact with, or otherwise access a content item available at the social networking system. Under conventional approaches, access to the content item can be provided to the user. For example, if the content item corresponds to an article and the user clicks on the content item, then the article can be provided for the user to read. In another example, if the content item corresponds to a video and the user clicks on the content item, then the video can be played for the user.

Under conventional approaches, users generally browse and search for content manually. In some cases, this can be uninteresting, inconvenient, or inefficient. Manual searching through browsing can be tedious. When the potential sources of relevant content are large, as is often true with some social networking services, efforts to conduct comprehensive, organized searching may be complicated and daunting. Further, the expenditure of such effort can result in the identification of content that is still less relevant than optimal. As such, conventional approaches can create challenges for or reduce the overall user experience associated with accessing content.

### SUMMARY

Various embodiments of the present disclosure can include systems, methods, and non-transitory computer readable media configured to identify a source content item for which related content is to be provided. A set of candidate content items associated with the source content item can be selected. The set of candidate content items can be ranked based, at least in part, on a set of engagement signals associated with the set of candidate content items. A subset of highest ranked candidate content items out of the set of candidate content items can be provided as the related content for the source content item.

In an embodiment, the selecting of the set of candidate content items can further comprise selecting each candidate content item in the set of candidate content items based on content selection criteria. In some cases, the content selection criteria can be associated with at least one of a topic similarity level between a respective candidate content item in the set of candidate content items and the source content item, a creator identity similarity level between the respective candidate content item and the source content item, a domain similarity level between the respective candidate content item and the source content item, or a collaborative filtering process for the respective candidate content item and the source content item.

In an embodiment, the set of candidate content items can be ranked based, at least in part, on information associated with the content selection criteria.

In an embodiment, the set of candidate content items can be ranked based, at least in part, on at least one of a domain quality level of a respective candidate content item in the set of candidate content items, a content originality level of the respective candidate content item, a content similarity level of the respective candidate content item relative to the set of candidate content items, or a personalization metric of the respective candidate content item.

In an embodiment, the ranking of the set of candidate content items based, at least in part, on the set of engagement signals can further comprise calculating a score for a respective candidate content item in the set of candidate content items based on one or more engagement signals, in the set of engagement signals, that are associated with the respective candidate content item. Respective candidate content items can be sorted based on scores for the respective candidate content items.

In an embodiment, the one or more engagement signals can indicate at least one of a click-through rate (CTR), a share amount, a like amount, or a hide amount.

In an embodiment, the score for the respective candidate content item can be higher when at least one of the click-through rate (CTR), the share amount, or the like amount is higher. In some cases, the score for the respective candidate content item can be lower when the hide amount is higher.

In an embodiment, the one or more engagement signals can be assessed in real-time. In some instances, the calculating of the score for the respective candidate content item can be performed in real-time. In some cases, the sorting of the respective candidate content items can be performed in real-time.

In an embodiment, a trigger to initiate the providing of the subset can be detected. In some cases, the trigger can be detected based on a user interaction with respect to the source content item.

In an embodiment, the user interaction with respect to the source content item can be associated with at least one of a click, a tap, a loading command, a share, or a like.

In an embodiment, the identifying of the source content item can further comprise detecting that the source content item has been posted. In some cases, it can be determined that the source content item is separate from other content items previously posted.

In an embodiment, the source content item can be associated with a first domain. In some cases, at least one content item in the subset of highest ranked candidate content items can be associated with a second domain.

In an embodiment, the source content item can be associated with a first content type, at least one content item in the subset of highest ranked candidate content items can be associated with a second content type, and each of the first content type and second content type can be associated with at least one of an image content type, an audio content type, a video content type, a content link type, or an article content type.

In an embodiment, the source content item can be identified from at least one of a social networking system, a third-party application, a third-party online resource, or a third-party service. In some cases, the subset of highest ranked candidate content items can be provided at the at least one of the social networking system, the third-party application, the third-party online resource, or the third-party service.

In an embodiment, the subset of highest ranked candidate content items can be provided in at least one of a vertical arrangement below the source content item or a horizontal arrangement below the source content item.

In an embodiment, the subset of highest ranked candidate content items can be vertically scrollable when provided in the vertical arrangement, and the subset of highest ranked candidate content items can be horizontally scrollable when provided in the horizontal arrangement.

In an embodiment, the source content item can include a first video displayed at a first position, at least one content item in the subset of highest ranked candidate content items can include a second video displayed at a second position, and the second video can be played in the first position in place of the first video when a user command to play the second video is received.

In an embodiment, additional related content for the second video can be provided.

Many other features and embodiments of the invention will be apparent from the accompanying drawings and from the following detailed description.

### BRIEF DESCRIPTION OF THE DRAWINGS

FIG. 1 illustrates an example system including an example related content module configured to facilitate ranking and providing content related to a source content item, according to an embodiment of the present disclosure.

FIG. 2 illustrates an example content selection module configured to facilitate selecting a set of content items potentially related to a source content item, according to an embodiment of the present disclosure.

FIG. 3 illustrates an example content ranking module configured to facilitate ranking a set of content items potentially related to a source content item, according to an embodiment of the present disclosure.

FIG. 4 illustrates an example screenshot associated with ranking and providing content related to a source content item, according to an embodiment of the present disclosure.

FIG. 5 illustrates an example screenshot associated with ranking and providing content related to a source content item, according to an embodiment of the present disclosure.

FIG. 6 illustrates an example screenshot associated with ranking and providing content related to a source content item, according to an embodiment of the present disclosure.

FIG. 7 illustrates an example method associated with ranking and providing content related to a source content item, according to an embodiment of the present disclosure.

FIG. 8 illustrates an example method associated with ranking and providing content related to a source content item, according to an embodiment of the present disclosure.

FIG. 9 illustrates a network diagram of an example system that can be utilized in various scenarios, according to an embodiment of the present disclosure.

FIG. 10 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Ranking and Providing Related Content

People use social networking systems (or services) for a wide variety of purposes. Users of a social networking system can utilize their computing devices (or systems) to establish connections, communicate, and interact with one another via the social networking system. Users can also provide, edit, share, or access content items such as articles, videos, images, audio, links, and various other content. In one example, a user of the social networking system can view or access content items provided to the user, such as via a news feed. In another example, the user can view or access content items available at his or her profile page (or timeline) or at another entity's page.

Conventional approaches to providing content items generally include presenting content items that the user has selected to access. After the user accesses these content items, additional content items can be presented to the user. In one example, under conventional approaches, the additional content items are chosen from the same domain as the accessed content items. In another example, the additional content items are chosen from the same sponsor as the accessed content items. As such, conventional approaches to providing access to media content items can be predictable and static. Furthermore, conventional approaches can provide access to content items in an inefficient or ineffective manner. This can create challenges for or reduce the overall user experience associated with accessing content items.

Therefore, an improved approach to providing access to content items can be beneficial for addressing or alleviating various concerns associated with conventional approaches. Various embodiments of the present disclosure can, for example, select a set of candidate content items that are associated with a given content item. The set of candidate content items can be ranked based on various factors such as engagement signals, which provide information about each candidate content item in the set. A subset of highest ranked candidate content items can be provided to the user as content related to the given content item. The user can access or view the provided related content. It is contemplated that many other uses, applications, and/or variations are also possible.

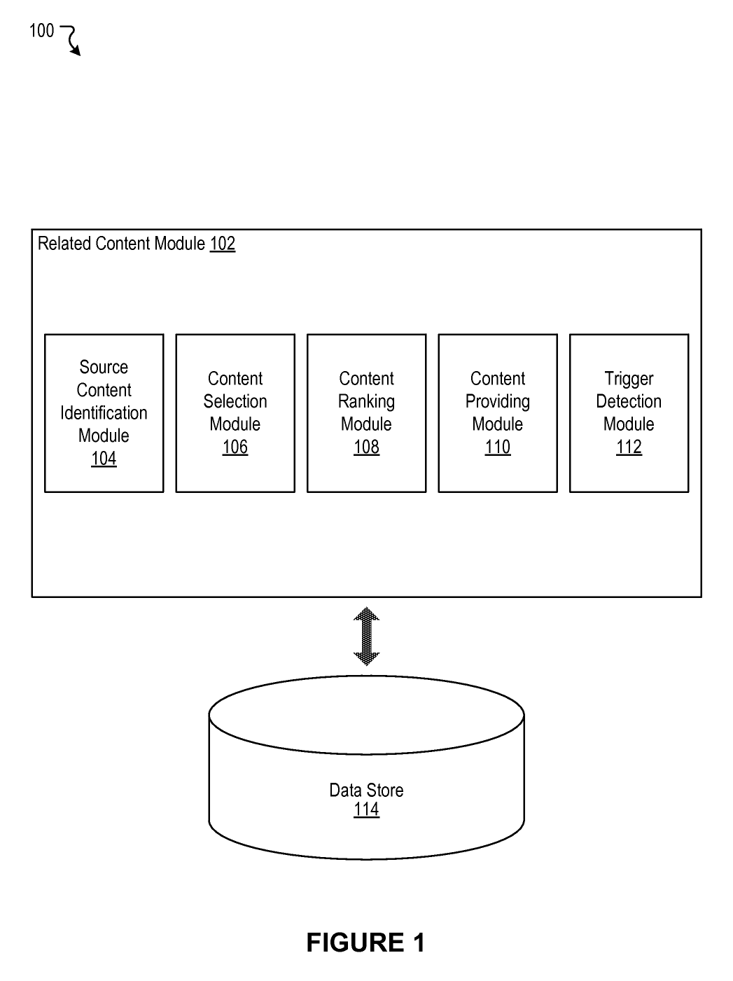

FIG. 1 illustrates an example system 100 including an example related content module 102 configured to facilitate ranking and providing content related to a source content item, according to an embodiment of the present disclosure. As shown in the example of FIG. 1, the related content module 102 can include a source content identification module 104, content selection module 106, a content ranking module 108, a content providing module 110, and a trigger detection module 112. In some implementations, the example system 100 can also include at least one data store 114.

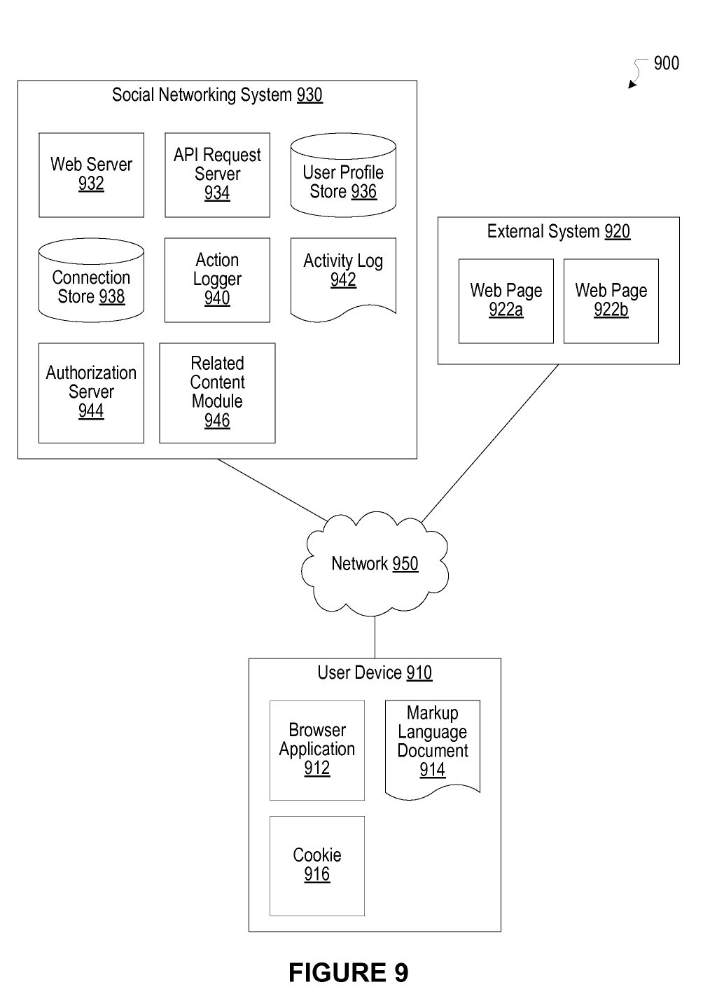

The at least one data store 114 can be configured to store and maintain data associated with a social networking system, such as the social networking system 930 of FIG. 9. For example, the at least one data store 114 can store and maintain information about content posted, published, provided, and/or available at the social networking system. In some cases, users of the social networking system can post or upload content items to the social networking system. The data store 114 can store the content items as well as information, such as properties, characteristics, metadata, etc., associated with the content items.

The source content identification module 104 can be configured to facilitate identifying the source content item for which related content is to be provided. In some embodiments, the source content identification module 104 can be configured to facilitate the identifying of the source content item by detecting that the source content item has been posted, and by determining that the source content item is separate from other content items previously posted. For example, the source content identification module 104 can detect that a content item corresponding to an article has been posted, and that the article itself has not been already posted, such as by another user. The source content identification module 104 can identify the content item as the source content item for which related content is to be provided. In some implementations, each newly posted and unique (or substantially unique) content item can be identified as a respective source content item.

In some embodiments, the source content identification module 104 can work in conjunction with the trigger detection module 112 to identify a source content item. More details with regard to the trigger detection module 112 will be discussed below.

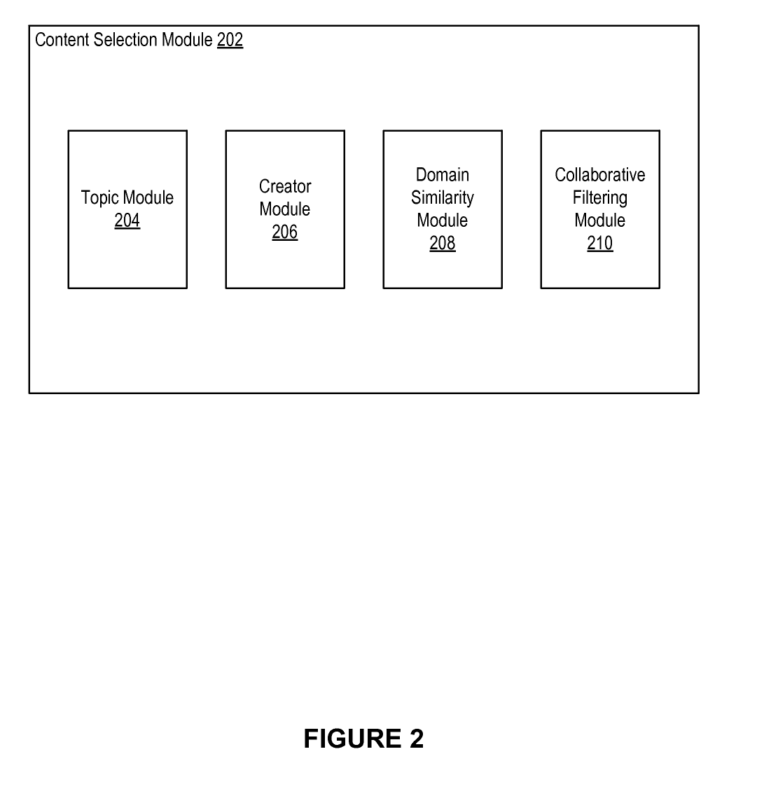

The content selection module 106 can be configured to facilitate selecting a set of candidate content items associated with the source content item. In some cases, the content selection module 106 can be configured to select a set of candidate content items that have the same or substantially the same topic, the same or substantially the same creator (e.g., author, uploader, etc.), and/or the same or substantially the same domain or sponsor. In some cases, the content selection module 106 can be configured to select the set of candidate content items based on a collaborative filtering process. Many variations are possible. More details with respect to the content selection module 106 will be discussed below with reference to FIG. 2.

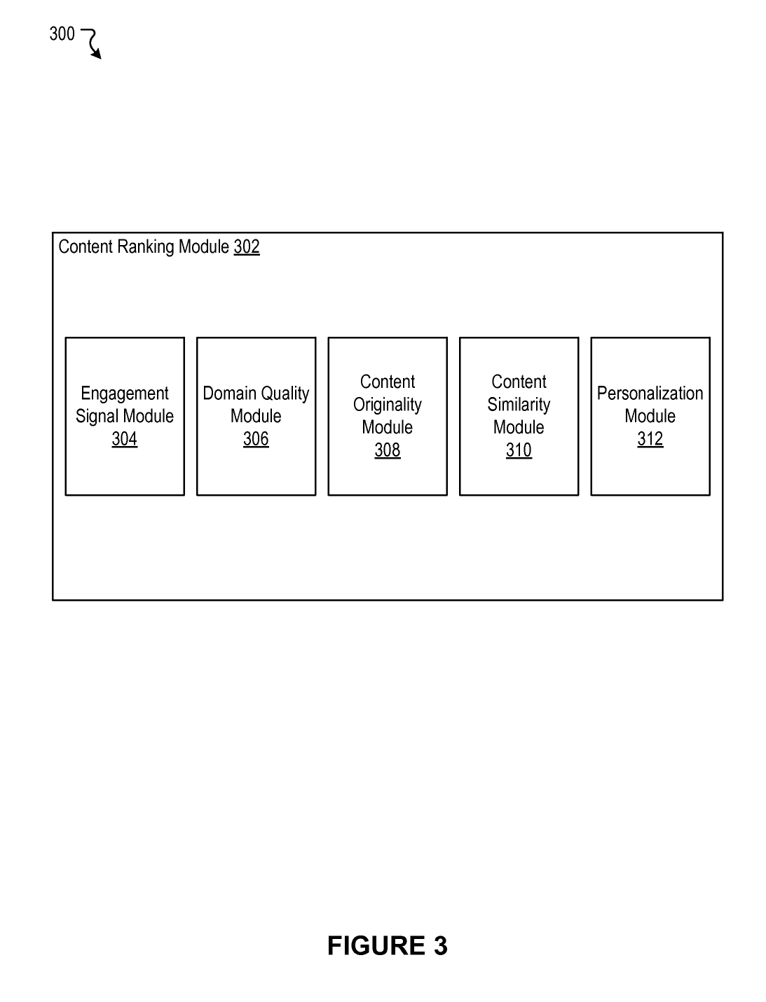

The content ranking module 108 can be configured to facilitate ranking the set of candidate content items based, at least in part, on a set of engagement signals associated with the set of candidate content items. In some cases, the content ranking module 108 can be configured to rank the set of candidate content items based on other factors as well. A more detailed discussion regarding the content ranking module 108 will be provided below with reference to FIG. 3.

The content providing module 110 can be configured to facilitate providing a subset of highest ranked candidate content items, out of the set of candidate content items, as the related content for the source content item. In some embodiments, the content providing module 110 can be configured to provide a specified quantity of highest ranked candidate content items as the related content for the source content item. In one example, the content providing module 110 can provide the top three highest ranked candidate content items as the related content. In some implementations, the subset of highest ranked candidate content items to be provided can be based on spatial and/or platform limitations associated with where the subset is to be provided. For example, in the case of a website, 10 highest ranked candidate content items can be provided on the website as the related content. In another example, five highest ranked candidate content items can be provided as the related content for an application on a tablet computing device. In a further example, the first highest ranked candidate content item can be provided as the related content for an application on a smartphone computing device.

Furthermore, the trigger detection module 112 can be configured to facilitate detecting a trigger to initiate the providing of the subset. In some instances, the trigger can be detected based on a user interaction with respect to the source content item. In some cases, the user interaction with respect to the source content item can be associated with at least one of a click, a tap, a loading command, a share, or a like. In one example, the related content for the source content item can be provided (e.g., displayed) when the user right clicks on the source content item. In another example, the related content for the source content item can be provided when the user loads the source content item. In some instances, the trigger (e.g., the user interaction) can occur on or off a social networking system, such as when the trigger occurs via one or more social plugins. Many variations are possible.

Moreover, in some cases, the trigger detection module 112 can work in conjunction with the source content identification module 104 to identify the source content item, as discussed above. In one example, the trigger detection module 112 can detect a user interaction (e.g., a click, a tap, a loading command, a share, a like, etc.) with respect to a particular content item. This information can be acquired or received by the source content identification module 104 from the trigger detection module 112. The source content identification module 104 can then identify the particular content item as being a source content item for which related content is to be provided.

FIG. 2 illustrates an example content selection module 202 configured to facilitate selecting a set of content items potentially related to a source content item, according to an embodiment of the present disclosure. For example, the content selection module 202 can select content items that are associated with the source content item to be included in the set (i.e., a set of candidate content items potentially related to the source content item). As shown, the content selection module 202 can include a topic module 204, a creator module 206, a domain similarity module 208, and a collaborative filtering module 210.

In some embodiments, the social networking system can identify, classify, and/or tag content items with respective topics. As such, the topic module 204 included in the content selection module 202 can be configured to acquire information about topics for various content items. The topic module 204 can acquire information about at least one topic associated with the source content item and identify one or more other content items that have substantially the same topic as the source content item. For example, the topic module 204 can determine that the source content item is associated with a particular topic. The topic module 204 can identify another content item associated with the same particular topic. In another example, the topic module 204 can identify another content item associated with a topic that has a level of similarity, with respect to the particular topic of the source content item, that meets (or surpasses) a specified threshold topic similarity level or score. The identified content item(s) can be selected to be in the set of candidate content items potentially related to the source content item based on topic association.

The creator module 206 included in the content selection module 202 can be configured to acquire information about creators associated with various content items. Examples of creators can include, but are not limited to, authors of content items, uploaders of content items, providers of content items, designers of content items, and/or originators of content items, etc. The creator module 206 can acquire information about at least one creator associated with the source content item and identify one or more other content items that have substantially the same creator as the source content item. For example, the creator module 206 can determine that the source content item is associated with a particular creator. The creator module 206 can identify another content item associated with the same particular creator. In another example, the creator module 206 can identify another content item associated with a creator that has a level of similarity, with respect to the particular creator of the source content item, that meets (or surpasses) a specified threshold creator similarity level or score. The identified content item(s) can be selected to be in the set of candidate content items potentially related to the source content item based on creator association.

The domain similarity module 208 can be configured to acquire information about domains associated with various content items. The domain similarity module 208 can acquire information about at least one domain associated with the source content item and identify other content items that have substantially the same domain as the source content item. In one example, the domain similarity module 208 can determine that the source content item is associated with a particular domain. The domain similarity module 208 can identify another content item associated with the same particular domain. In another example, the domain similarity module 208 can identify another content item associated with a domain that has a level of similarity, with respect to the particular domain of the source content item, that meets (or surpasses) a specified threshold domain similarity level or score. The identified content item(s) can be selected to be in the set of candidate content items potentially related to the source content item based on domain association.

The collaborative filtering module 210 can be configured to utilize at least one collaborative filtering process to identify and select one or more content items to be included in the set of candidate content items associated with and potentially related to the source content item. The at least one collaborative filtering process can acquire information about various interactions and/or activities of users. In one example, the collaborative filtering module 210 can acquire information about users of the social networking system. The information about the users can indicate which content items and/or other objects the users liked, supported, shared, and/or promoted, etc. In this example, the collaborative filtering module 210 can utilize the collaborative filtering process to determine that a threshold number of users who positively interacted with (e.g., liked, shared, etc.) the source content item also positively interacted with one or more other content items. Accordingly, in this example, the collaborative filtering module 210 can select the one or more other content items to be included in the set of candidate content items potentially related to the source content item based on associations determined via collaborative filtering.

It should be noted that the examples provided above are for illustrative purposes. It is contemplated that the content selection module 202 can also utilize many other approaches to select the set of candidate content items.

Moreover, in some embodiments, content selection criteria can be associated with a topic similarity level between a respective candidate content item in the set of candidate content items and the source content item, a creator identity similarity level between the respective candidate content item and the source content item, a domain similarity level between the respective candidate content item and the source content item, and/or a collaborative filtering process for the respective candidate content item and the source content item, as discussed above. In some implementations, the set of candidate content items can be selected based, at least in part, on the content selection criteria. Furthermore, in some implementations, the set of candidate content items can be ranked based, at least in part, on information associated with the content selection criteria.

FIG. 3 illustrates an example content ranking module 302 configured to facilitate ranking a set of content items potentially related to a source content item (also referred to as a set of candidate content items), according to an embodiment of the present disclosure. In some embodiments, the content ranking module 302 can rank the set of candidate content items based on a set of engagement signals associated with the set of candidate content items. In some embodiments, the content ranking module 302 can rank the set of candidate content items based on other factors. As shown in the example of FIG. 3, the content ranking module 302 can include an engagement signal module 304, a domain quality module 306, a content originality module 308, a content similarity module 310, and a personalization module 312.

The engagement signal module 304 can be configured to facilitate ranking the set of candidate content items based, at least in part, on the set of engagement signals. In some instances, the engagement signal module 304 can calculate a score for each respective candidate content item in the set of candidate content items. The score can be calculated based on one or more engagement signals, in the set of engagement signals, that are associated with the respective candidate content item. In some implementations, the one or more engagement signals can indicate at least one of a click-through rate (CTR), a share amount, a like amount, or a hide amount associated with respective candidate content item. Moreover, the engagement signal module 304 can sort the respective candidate content items based on scores for the respective candidate content items. In some cases, the score for the respective candidate content item can be higher when at least one of the click-through rate (CTR), the share amount, or the like amount is higher and/or when the hide amount is lower. In some cases, the score for the respective candidate content item can be lower when at least one of the click-through rate (CTR), the share amount, or the like amount is lower and/or when the hide amount is higher.

In one example, the engagement signal module 304 can determine that a first candidate content item is associated with a first engagement signal. The engagement signal module 304 can acquire information about the first engagement signal indicating that the first candidate content item has been liked, supported, or up-voted 500 times. In this example, the engagement signal module 304 can also determine that a second candidate content item is associated with a second engagement signal, which indicates that the second candidate content item has been liked, supported, or up-voted 20 times. As such, a first score calculated by the engagement signal module 304 for the first candidate content item can be higher than a second score calculated for the second candidate content item. It follows that the engagement signal module 304 can sort the first candidate content item higher in rank than the second candidate content item.

In some implementations, the engagement signals can be assessed in real-time (or near real-time). As such, the calculating of the score for the respective candidate content item can be performed in real-time. It also follows that the sorting of the respective candidate content items can be performed in real-time.

In some embodiments, the ranking of the set of candidate content items can be based, at least in part, on at least one of a domain quality level of a respective candidate content item in the set of candidate content items, a content originality level of the respective candidate content item, a content similarity level of the respective candidate content item relative to the set of candidate content items, or a personalization metric of the respective candidate content item. In some cases, the domain quality module 306 can be configured to acquire information about a domain associated with the respective candidate content item. The information can indicate the quality level of the domain, such as whether or not the domain is reputable and legitimate. For example, if the domain associated with the respective candidate content item is illegitimate or spam-related, then the domain quality level can be lower and the respective candidate content item can be ranked lower. If the domain is legitimate, then the domain quality level can be higher and the respective candidate content item can be ranked higher.

In addition, the content originality module 308 can be configured to acquire information about an originality level for the respective candidate content item. If the respective candidate content item has a higher originality level, then the respective candidate content item is more likely to be original and/or unique. If the respective candidate content item has a lower originality level, then the respective candidate content item is less likely to be original and/or unique. For example, memes and other trending or commonplace content items that have already been posted and publicized can have lower originality levels. Accordingly, if the respective candidate content item has a lower originality level, then the respective candidate content item can be ranked lower, and vice versa for a higher originality level.

In some instances, the content similarity module 310 can be configured to acquire information about a similarity level of the respective candidate content item relative to the set of candidate content items. The similarity level of the respective candidate content item can indicate how similar the respective candidate content item is, relative to the other candidate content items in the set. If the similarity level of the respective candidate content item is higher, then the respective candidate content item can be ranked lower, because it can be undesirable in some cases to provide too much similar content. Alternatively, if the similarity level of the respective candidate content item is lower, then the respective candidate content item can be ranked higher.

Further, the personalization module 312 can be configured to acquire a personalization metric of the respective candidate content item. The personalization metric can indicate a level of relevance specific to a particular user who is accessing or interacting with the source content item. In some cases, if the user likes, shares, or otherwise positively interacts with a certain topic, subject matter, or area of interest, and if the respective candidate content item is associated with the topic, subject matter, or area of interest, then the personalization metric of the respective candidate content item can be higher and the respective candidate content item can be ranked higher (and vice versa). In one example, if the user is an engineer living in San Francisco, Calif., and the respective candidate content item is associated with a bay area technological event, then the personalization metric can be higher. Accordingly, the respective candidate content item can be ranked higher when the personalization metric is higher, and vice versa when the personalization metric is lower.

As set forth herein, a candidate content item can be ranked higher or ranked lower based on a level or metric associated with such factors as engagement signal, domain quality, content originality, content similarity, and personalization. In some embodiments, a higher ranking for a candidate content item can mean an attendant increase in the ranking of the candidate content item from an initial ranking of the candidate content item when a level, value, or metric associated with engagement signal, domain quality, content originality, content similarity, or personalization is increased from an initial (or threshold) value. Likewise, in some embodiments, a lower ranking for a candidate content item can mean an attendant decrease in the ranking of the candidate content item from an initial ranking of the candidate content item when a level, value, or metric associated with engagement signal, domain quality, content originality, content similarity, or personalization is decreased from an initial (or threshold) value. In some embodiments, a ranking of a candidate content item can increase (or decrease) with an increase (or decrease) in a level, value, or metric associated with engagement signal, domain quality, content originality, content similarity, or personalization.

In addition, it should be noted that the examples provided above are for illustrative purposes. It is contemplated that the content ranking module 302 can also utilize many other approaches to rank the set of candidate content items. In one example, each factor informing a content ranking for a candidate content item, such as engagement signal, domain quality, content originality, content similarity, and personalization, can be provided a selected weight and the factors can be combined according to their weights to determine the content ranking.

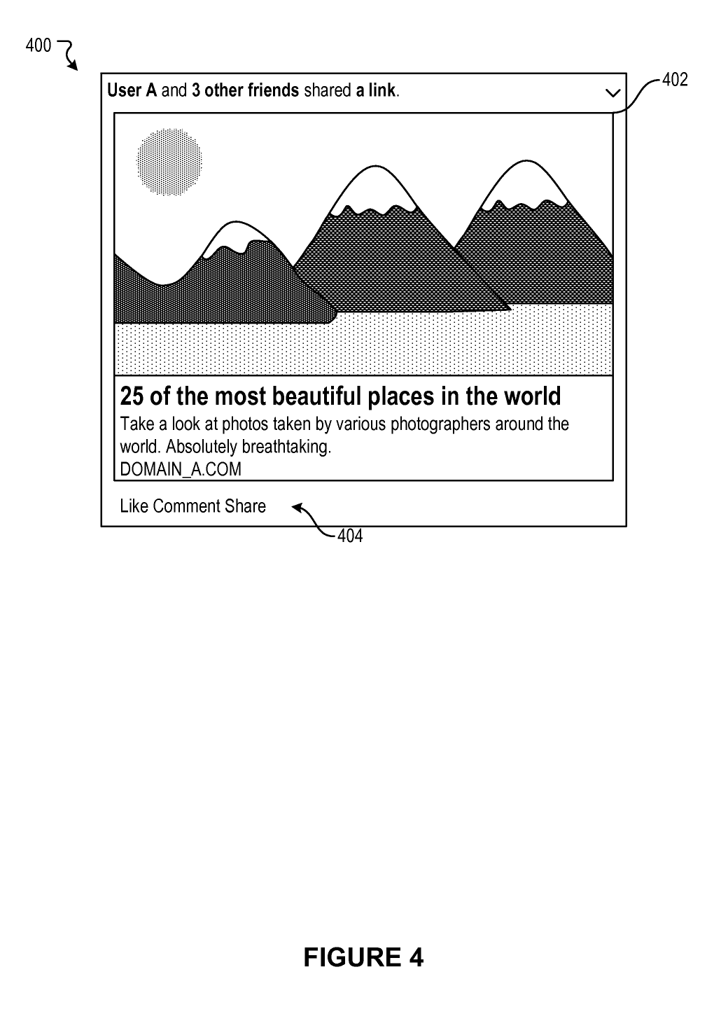

FIG. 4 illustrates an example screenshot 400 associated with ranking and providing content related to a source content item, according to an embodiment of the present disclosure. The example screenshot 400 includes an example source content item 402. In FIG. 4, the source content item 402 can, for example, correspond to a story or a post provided at a social networking system user's newsfeed, content feed, timeline, profile, or wall, etc. The user can access or otherwise interact with the example source content item 402 to cause related content (not shown in the example of FIG. 4) to be provided.

In one example, the related content can be provided when the user attempts to access the source content item 402, such as by clicking on, tapping on, and/or loading, etc., the source content item. In another example, the related content can be provided when the user engages and/or interacts with the source content item 402, such as by liking, up-voting, promoting, and/or sharing (e.g., via elements 404) the source content item.

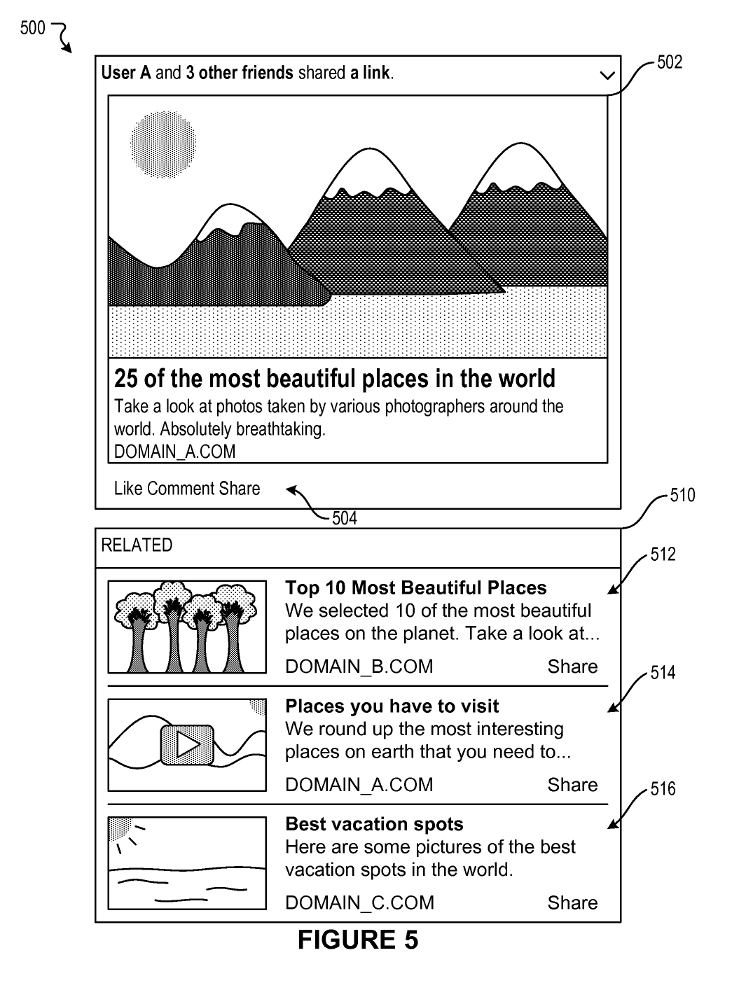

FIG. 5 illustrates an example screenshot 500 associated with ranking and providing content related to a source content item, according to an embodiment of the present disclosure. The example screenshot 500 includes an example source content item 502. A user can access or otherwise interact with (e.g., via elements 504) the example source content item 502 to cause related content 510 to be provided.

As discussed above, a subset of highest ranked candidate content items, out of a set of candidate content items, can be provided as the related content for the source content item. In some implementations, the subset of highest ranked candidate content items can be provided in a vertical arrangement below the source content item. In some cases, the subset of highest ranked candidate content items can be vertically scrollable when provided in the vertical arrangement. As shown, the subset of highest ranked candidate content items can include three vertically arranged content items (e.g., item 512, item 514, and item 516). Other arrangements of the subset of highest ranked candidate content items are possible.

In the example of FIG. 5, the source content item 502 can be associated with a first domain (e.g., DOMAIN_A.COM) and at least one content item (e.g., item 512, item 516) in the subset of highest ranked candidate content items can be associated with a second domain (e.g., DOMAIN_B.COM, DOMAIN_C.COM).

Moreover, in some implementations, each content item can be associated with a respective content type, such as an image content type, an audio content type, a video content type, a content link type, or an article content type. In this example, the source content item 502 can be associated with a first content type (e.g., article content type) and at least one content item (e.g., item 514) in the subset of highest ranked candidate content items can be associated with a second content type (e.g., video content type).

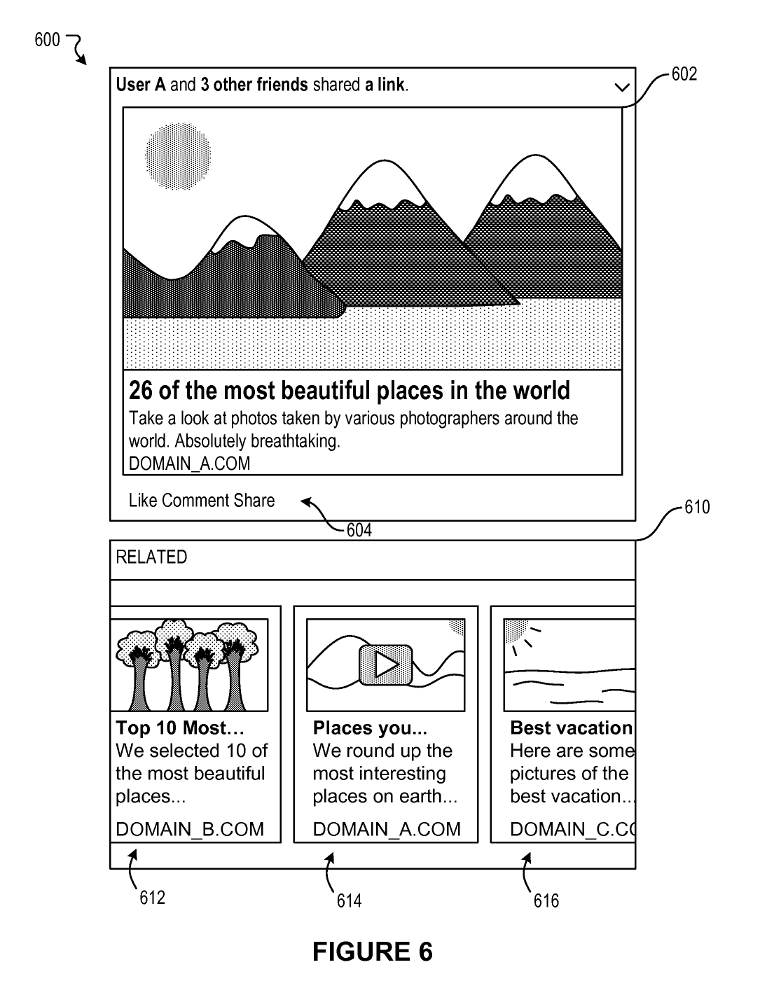

FIG. 6 illustrates an example screenshot 600 associated with ranking and providing content related to a source content item, according to an embodiment of the present disclosure. The example screenshot 600 includes an example source content item 602. Interactions with (e.g., via elements 604) the example source content item 602 can cause related content 610 to be provided.

As discussed, the subset of highest ranked candidate content items can correspond to the related content 610. In some instances, the subset can be provided in a horizontal arrangement below the source content item 602. In some cases, the subset of highest ranked candidate content items can be horizontally scrollable when provided in the horizontal arrangement. As shown, the subset can include three horizontally arranged content items (e.g., item 612, item 614, and item 616).

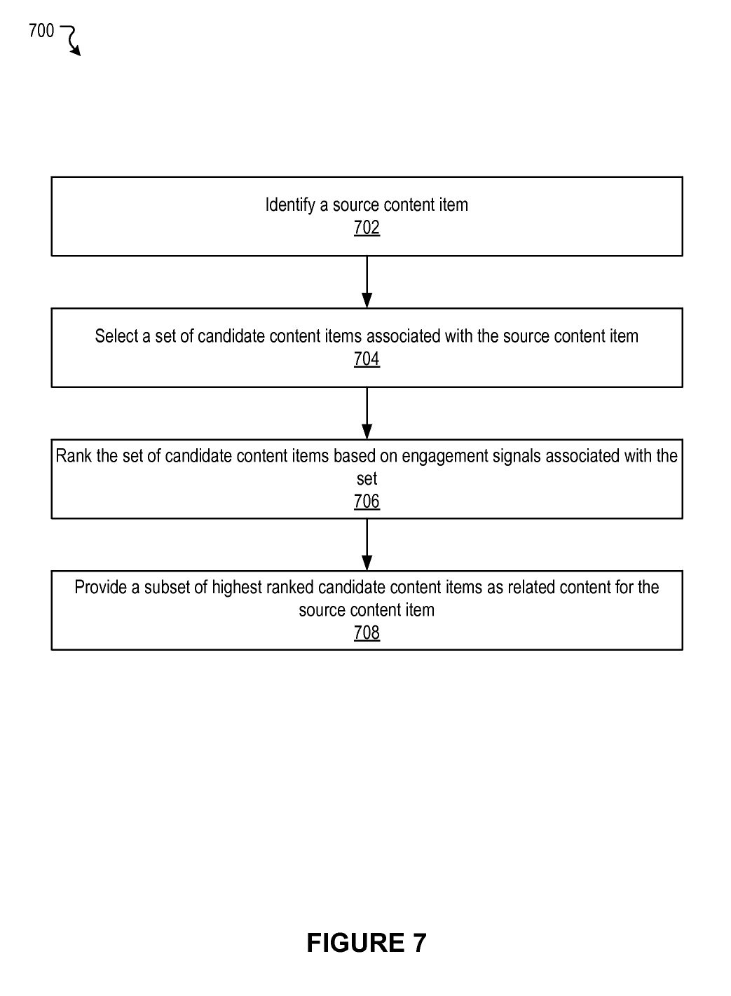

FIG. 7 illustrates an example method 700 associated with ranking and providing content related to a source content item, according to an embodiment of the present disclosure. It should be appreciated that there can be additional, fewer, or alternative steps performed in similar or alternative orders, or in parallel, within the scope of the various embodiments unless otherwise stated.

At block 702, the example method 700 can identify a source content item for which related content is to be provided. At block 704, the example method 700 can select a set of candidate content items associated with the source content item. At block 706, the example method 700 can rank the set of candidate content items based, at least in part, on a set of engagement signals associated with the set of candidate content items. At block 708, the example method 700 can provide a subset of highest ranked candidate content items out of the set of candidate content items as the related content for the source content item.

In some embodiments, each candidate content item in the set of candidate content items can be selected based on content selection criteria. In some instances, the content selection criteria can be associated with at least one of a topic similarity level between a respective candidate content item in the set of candidate content items and the source content item, a creator identity similarity level between the respective candidate content item and the source content item, a domain similarity level between the respective candidate content item and the source content item, or a collaborative filtering process for the respective candidate content item and the source content item.

In some embodiments, the set of candidate content items can be ranked based, at least in part, on information associated with the content selection criteria.

In some embodiments, the set of candidate content items can be ranked based, at least in part, on at least one of a domain quality level of a respective candidate content item in the set of candidate content items, a content originality level of the respective candidate content item, a content similarity level of the respective candidate content item relative to the set of candidate content items, or a personalization metric of the respective candidate content item.

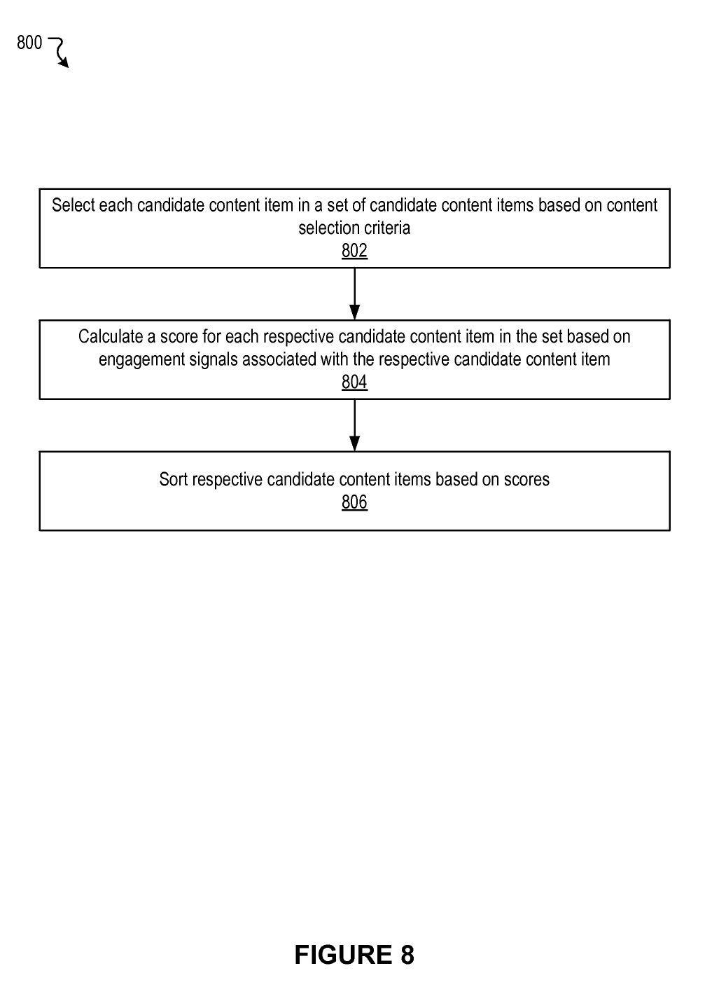

FIG. 8 illustrates an example method 800 associated with ranking and providing content related to a source content item, according to an embodiment of the present disclosure. Again, it should be understood that there can be additional, fewer, or alternative steps performed in similar or alternative orders, or in parallel, within the scope of the various embodiments unless otherwise stated.

At block 802, the example method 800 can select each candidate content item in the set of candidate content items based on content selection criteria. In some cases, the content selection criteria can be associated with at least one of a topic similarity level between a respective candidate content item in the set of candidate content items and the source content item, a creator identity similarity level between the respective candidate content item and the source content item, a domain similarity level between the respective candidate content item and the source content item, or a collaborative filtering process for the respective candidate content item and the source content item.

At block 804, the example method 800 can calculate a score for each respective candidate content item in the set of candidate content items based on one or more engagement signals, in the set of engagement signals, that are associated with the respective candidate content item.

At block 806, the example method 800 can sort respective candidate content items based on scores for the respective candidate content items.

In some embodiments, the source content item can be identified from at least one of a social networking system, a third-party application, a third-party online resource, or a third-party service. In some instances, the subset of highest ranked candidate content items can be provided by or to the at least one of the social networking system, the third-party application, the third-party online resource, or the third-party service.

Furthermore, in some embodiments, the source content item can include a first video displayed at a first position. In some cases, the first position can correspond to a particular location on a user interface or display. At least one content item in the subset of highest ranked candidate content items can include a second video displayed at a second position. In some cases, the second position can correspond to another location on the user interface or display. The second video can be played in the first position in place of the first video when a user command to play the second video is received. In some instances, additional related content for the second video can be provided, such by displaying at least a related third video at the second position.

Again, it is contemplated that there can be many other uses, applications, and/or variations associated with the various embodiments of the present disclosure. For example, various embodiments of the present disclosure can learn, improve, and/or be refined over time.

### Social Networking System—Example Implementation

FIG. 9 illustrates a network diagram of an example system 900 that can be utilized in various embodiments for enhanced video encoding, in accordance with an embodiment of the present disclosure. The system 900 includes one or more user devices 910, one or more external systems 920, a social networking system (or service) 930, and a network 950. In an embodiment, the social networking service, provider, and/or system discussed in connection with the embodiments described above may be implemented as the social networking system 930. For purposes of illustration, the embodiment of the system 900, shown by FIG. 9, includes a single external system 920 and a single user device 910. However, in other embodiments, the system 900 may include more user devices 910 and/or more external systems 920. In certain embodiments, the social networking system 930 is operated by a social network provider, whereas the external systems 920 are separate from the social networking system 930 in that they may be operated by different entities. In various embodiments, however, the social networking system 930 and the external systems 920 operate in conjunction to provide social networking services to users (or members) of the social networking system 930. In this sense, the social networking system 930 provides a platform or backbone, which other systems, such as external systems 920, may use to provide social networking services and functionalities to users across the Internet.

The user device 910 comprises one or more computing devices that can receive input from a user and transmit and receive data via the network 950. In one embodiment, the user device 910 is a conventional computer system executing, for example, a Microsoft Windows compatible operating system (OS), Apple OS X, and/or a Linux distribution. In another embodiment, the user device 910 can be a device having computer functionality, such as a smart-phone, a tablet, a personal digital assistant (PDA), a mobile telephone, etc. The user device 910 is configured to communicate via the network 950. The user device 910 can execute an application, for example, a browser application that allows a user of the user device 910 to interact with the social networking system 930. In another embodiment, the user device 910 interacts with the social networking system 930 through an application programming interface (API) provided by the native operating system of the user device 910, such as iOS and ANDROID. The user device 910 is configured to communicate with the external system 920 and the social networking system 930 via the network 950, which may comprise any combination of local area and/or wide area networks, using wired and/or wireless communication systems.

In one embodiment, the network 950 uses standard communications technologies and protocols. Thus, the network 950 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 950 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 950 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 910 may display content from the external system 920 and/or from the social networking system 930 by processing a markup language document 914 received from the external system 920 and from the social networking system 930 using a browser application 912. The markup language document 914 identifies content and one or more instructions describing formatting or presentation of the content. By executing the instructions included in the markup language document 914, the browser application 912 displays the identified content using the format or presentation described by the markup language document 914. For example, the markup language document 914 includes instructions for generating and displaying a web page having multiple frames that include text and/or image data retrieved from the external system 920 and the social networking system 930. In various embodiments, the markup language document 914 comprises a data file including extensible markup language (XML) data, extensible hypertext markup language (XHTML) data, or other markup language data. Additionally, the markup language document 914 may include JavaScript Object Notation (JSON) data, JSON with padding (JSONP), and JavaScript data to facilitate data-interchange between the external system 920 and the user device 910. The browser application 912 on the user device 910 may use a JavaScript compiler to decode the markup language document 914.

The markup language document 914 may also include, or link to, applications or application frameworks such as FLASH™ or Unity™ applications, the SilverLight™ application framework, etc.

In one embodiment, the user device 910 also includes one or more cookies 916 including data indicating whether a user of the user device 910 is logged into the social networking system 930, which may enable modification of the data communicated from the social networking system 930 to the user device 910.

The external system 920 includes one or more web servers that include one or more web pages 922a, 922b, which are communicated to the user device 910 using the network 950. The external system 920 is separate from the social networking system 930. For example, the external system 920 is associated with a first domain, while the social networking system 930 is associated with a separate social networking domain. Web pages 922a, 922b, included in the external system 920, comprise markup language documents 914 identifying content and including instructions specifying formatting or presentation of the identified content.

The social networking system 930 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 930 may be administered, managed, or controlled by an operator. The operator of the social networking system 930 may be a human being, an automated application, or a series of applications for managing content, regulating policies, and collecting usage metrics within the social networking system 930. Any type of operator may be used.

Users may join the social networking system 930 and then add connections to any number of other users of the social networking system 930 to whom they desire to be connected. As used herein, the term “friend” refers to any other user of the social networking system 930 to whom a user has formed a connection, association, or relationship via the social networking system 930. For example, in an embodiment, if users in the social networking system 930 are represented as nodes in the social graph, the term “friend” can refer to an edge formed between and directly connecting two user nodes.

Connections may be added explicitly by a user or may be automatically created by the social networking system 930 based on common characteristics of the users (e.g., users who are alumni of the same educational institution). For example, a first user specifically selects a particular other user to be a friend. Connections in the social networking system 930 are usually in both directions, but need not be, so the terms “user” and “friend” depend on the frame of reference. Connections between users of the social networking system 930 are usually bilateral (“two-way”), or “mutual,” but connections may also be unilateral, or “one-way.” For example, if Bob and Joe are both users of the social networking system 930 and connected to each other, Bob and Joe are each other's connections. If, on the other hand, Bob wishes to connect to Joe to view data communicated to the social networking system 930 by Joe, but Joe does not wish to form a mutual connection, a unilateral connection may be established. The connection between users may be a direct connection; however, some embodiments of the social networking system 930 allow the connection to be indirect via one or more levels of connections or degrees of separation.

In addition to establishing and maintaining connections between users and allowing interactions between users, the social networking system 930 provides users with the ability to take actions on various types of items supported by the social networking system 930. These items may include groups or networks (i.e., social networks of people, entities, and concepts) to which users of the social networking system 930 may belong, events or calendar entries in which a user might be interested, computer-based applications that a user may use via the social networking system 930, transactions that allow users to buy or sell items via services provided by or through the social networking system 930, and interactions with advertisements that a user may perform on or off the social networking system 930. These are just a few examples of the items upon which a user may act on the social networking system 930, and many others are possible. A user may interact with anything that is capable of being represented in the social networking system 930 or in the external system 920, separate from the social networking system 930, or coupled to the social networking system 930 via the network 950.

The social networking system 930 is also capable of linking a variety of entities. For example, the social networking system 930 enables users to interact with each other as well as external systems 920 or other entities through an API, a web service, or other communication channels. The social networking system 930 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 930. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 930 modifies edges connecting the various nodes to reflect the relationships and interactions.

The social networking system 930 also includes user-generated content, which enhances a user's interactions with the social networking system 930. User-generated content may include anything a user can add, upload, send, or “post” to the social networking system 930. For example, a user communicates posts to the social networking system 930 from a user device 910. Posts may include data such as status updates or other textual data, location information, images such as photos, videos, links, music or other similar data and/or media. Content may also be added to the social networking system 930 by a third party. Content “items” are represented as objects in the social networking system 930. In this way, users of the social networking system 930 are encouraged to communicate with each other by posting text and content items of various types of media through various communication channels. Such communication increases the interaction of users with each other and increases the frequency with which users interact with the social networking system 930.

The social networking system 930 includes a web server 932, an API request server 934, a user profile store 936, a connection store 938, an action logger 940, an activity log 942, and an authorization server 944. In an embodiment of the invention, the social networking system 930 may include additional, fewer, or different components for various applications. Other components, such as network interfaces, security mechanisms, load balancers, failover servers, management and network operations consoles, and the like are not shown so as to not obscure the details of the system.

The user profile store 936 maintains information about user accounts, including biographic, demographic, and other types of descriptive information, such as work experience, educational history, hobbies or preferences, location, and the like that has been declared by users or inferred by the social networking system 930. This information is stored in the user profile store 936 such that each user is uniquely identified. The social networking system 930 also stores data describing one or more connections between different users in the connection store 938. The connection information may indicate users who have similar or common work experience, group memberships, hobbies, or educational history. Additionally, the social networking system 930 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 930, such as non-person entities, buckets, cluster centers, images, interests, pages, external systems, concepts, and the like are also stored in the connection store 938.

The social networking system 930 maintains data about objects with which a user may interact. To maintain this data, the user profile store 936 and the connection store 938 store instances of the corresponding type of objects maintained by the social networking system 930. Each object type has information fields that are suitable for storing information appropriate to the type of object. For example, the user profile store 936 contains data structures with fields suitable for describing a user's account and information related to a user's account. When a new object of a particular type is created, the social networking system 930 initializes a new data structure of the corresponding type, assigns a unique object identifier to it, and begins to add data to the object as needed. This might occur, for example, when a user becomes a user of the social networking system 930, the social networking system 930 generates a new instance of a user profile in the user profile store 936, assigns a unique identifier to the user account, and begins to populate the fields of the user account with information provided by the user.

The connection store 938 includes data structures suitable for describing a user's connections to other users, connections to external systems 920 or connections to other entities. The connection store 938 may also associate a connection type with a user's connections, which may be used in conjunction with the user's privacy setting to regulate access to information about the user. In an embodiment of the invention, the user profile store 936 and the connection store 938 may be implemented as a federated database.

Data stored in the connection store 938, the user profile store 936, and the activity log 942 enables the social networking system 930 to generate the social graph that uses nodes to identify various objects and edges connecting nodes to identify relationships between different objects. For example, if a first user establishes a connection with a second user in the social networking system 930, user accounts of the first user and the second user from the user profile store 936 may act as nodes in the social graph. The connection between the first user and the second user stored by the connection store 938 is an edge between the nodes associated with the first user and the second user. Continuing this example, the second user may then send the first user a message within the social networking system 930. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 930 (or, alternatively, in an image maintained by another system outside of the social networking system 930). The image may itself be represented as a node in the social networking system 930. This tagging action may create edges between the first user and the second user as well as create an edge between each of the users and the image, which is also a node in the social graph. In yet another example, if a user confirms attending an event, the user and the event are nodes obtained from the user profile store 936, where the attendance of the event is an edge between the nodes that may be retrieved from the activity log 942. By generating and maintaining the social graph, the social networking system 930 includes data describing many different types of objects and the interactions and connections among those objects, providing a rich source of socially relevant information.

The web server 932 links the social networking system 930 to one or more user devices 910 and/or one or more external systems 920 via the network 950. The web server 932 serves web pages, as well as other web-related content, such as Java, JavaScript, Flash, XML, and so forth. The web server 932 may include a mail server or other messaging functionality for receiving and routing messages between the social networking system 930 and one or more user devices 910. The messages can be instant messages, queued messages (e.g., email), text and SMS messages, or any other suitable messaging format.

The API request server 934 allows one or more external systems 920 and user devices 910 to call access information from the social networking system 930 by calling one or more API functions. The API request server 934 may also allow external systems 920 to send information to the social networking system 930 by calling APIs. The external system 920, in one embodiment, sends an API request to the social networking system 930 via the network 950, and the API request server 934 receives the API request. The API request server 934 processes the request by calling an API associated with the API request to generate an appropriate response, which the API request server 934 communicates to the external system 920 via the network 950. For example, responsive to an API request, the API request server 934 collects data associated with a user, such as the user's connections that have logged into the external system 920, and communicates the collected data to the external system 920. In another embodiment, the user device 910 communicates with the social networking system 930 via APIs in the same manner as external systems 920.

The action logger 940 is capable of receiving communications from the web server 932 about user actions on and/or off the social networking system 930. The action logger 940 populates the activity log 942 with information about user actions, enabling the social networking system 930 to discover various actions taken by its users within the social networking system 930 and outside of the social networking system 930. Any action that a particular user takes with respect to another node on the social networking system 930 may be associated with each user's account, through information maintained in the activity log 942 or in a similar database or other data repository. Examples of actions taken by a user within the social networking system 930 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 930, the action is recorded in the activity log 942. In one embodiment, the social networking system 930 maintains the activity log 942 as a database of entries. When an action is taken within the social networking system 930, an entry for the action is added to the activity log 942. The activity log 942 may be referred to as an action log.

Additionally, user actions may be associated with concepts and actions that occur within an entity outside of the social networking system 930, such as an external system 920 that is separate from the social networking system 930. For example, the action logger 940 may receive data describing a user's interaction with an external system 920 from the web server 932. In this example, the external system 920 reports a user's interaction according to structured actions and objects in the social graph.

Other examples of actions where a user interacts with an external system 920 include a user expressing an interest in an external system 920 or another entity, a user posting a comment to the social networking system 930 that discusses an external system 920 or a web page 922a within the external system 920, a user posting to the social networking system 930 a Uniform Resource Locator (URL) or other identifier associated with an external system 920, a user attending an event associated with an external system 920, or any other action by a user that is related to an external system 920. Thus, the activity log 942 may include actions describing interactions between a user of the social networking system 930 and an external system 920 that is separate from the social networking system 930.

The authorization server 944 enforces one or more privacy settings of the users of the social networking system 930. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 920, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 920. One embodiment allows the specification of the set of entities to comprise an enumeration of entities. For example, the user may provide a list of external systems 920 that are allowed to access certain information. Another embodiment allows the specification to comprise a set of entities along with exceptions that are not allowed to access the information. For example, a user may allow all external systems 920 to access the user's work information, but specify a list of external systems 920 that are not allowed to access the work information. Certain embodiments call the list of exceptions that are not allowed to access certain information a “block list”. External systems 920 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 944 contains logic to determine if certain information associated with a user can be accessed by a user's friends, external systems 920, and/or other applications and entities. The external system 920 may need authorization from the authorization server 944 to access the user's more private and sensitive information, such as the user's work phone number. Based on the user's privacy settings, the authorization server 944 determines if another user, the external system 920, an application, or another entity is allowed to access information associated with the user, including information about actions taken by the user.

In some embodiments, the social networking system 930 can include a related content module 946. The related content module 946 can, for example, be implemented as the related content module 102 of FIG. 1. The related content module 946 can be configured to facilitate identifying a source content item for which related content is to be provided. The related content module 946 can be configured to facilitate selecting a set of candidate content items associated with the source content item. The related content module 946 can also be configured to facilitate ranking the set of candidate content items based, at least in part, on a set of engagement signals and other factors associated with the set of candidate content items. The related content module 946 can further be configured to facilitate providing a subset of highest ranked candidate content items out of the set of candidate content items as the related content for the source content item. It is understood that many variations are possible.

### Hardware Implementation

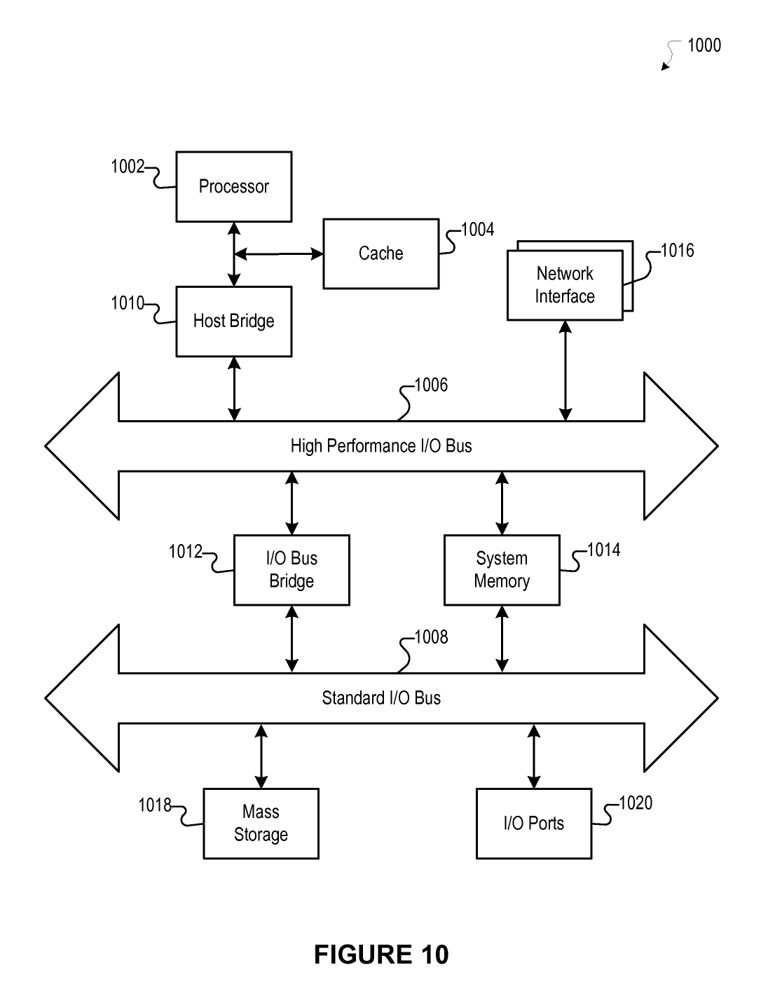

The foregoing processes and features can be implemented by a wide variety of machine and computer system architectures and in a wide variety of network and computing environments. FIG. 10 illustrates an example of a computer system 1000 that may be used to implement one or more of the embodiments described herein in accordance with an embodiment of the invention. The computer system 1000 includes sets of instructions for causing the computer system 1000 to perform the processes and features discussed herein. The computer system 1000 may be connected (e.g., networked) to other machines. In a networked deployment, the computer system 1000 may operate in the capacity of a server machine or a client machine in a client-server network environment, or as a peer machine in a peer-to-peer (or distributed) network environment. In an embodiment of the invention, the computer system 1000 may be the social networking system 1030, the user device 910, and the external system 1020, or a component thereof. In an embodiment of the invention, the computer system 1000 may be one server among many that constitutes all or part of the social networking system 1030.

The computer system 1000 includes a processor 1002, a cache 1004, and one or more executable modules and drivers, stored on a computer-readable medium, directed to the processes and features described herein. Additionally, the computer system 1000 includes a high performance input/output (I/O) bus 1006 and a standard I/O bus 1008. A host bridge 1010 couples processor 1002 to high performance I/O bus 1006, whereas I/O bus bridge 1012 couples the two buses 1006 and 1008 to each other. A system memory 1014 and one or more network interfaces 1016 couple to high performance I/O bus 1006. The computer system 1000 may further include video memory and a display device coupled to the video memory (not shown). Mass storage 1018 and I/O ports 1020 couple to the standard I/O bus 1008. The computer system 1000 may optionally include a keyboard and pointing device, a display device, or other input/output devices (not shown) coupled to the standard I/O bus 1008. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1000 are described in greater detail below. In particular, the network interface 1016 provides communication between the computer system 1000 and any of a wide range of networks, such as an Ethernet (e.g., IEEE 802.3) network, a backplane, etc. The mass storage 1018 provides permanent storage for the data and programming instructions to perform the above-described processes and features implemented by the respective computing systems identified above, whereas the system memory 1014 (e.g., DRAM) provides temporary storage for the data and programming instructions when executed by the processor 1002. The I/O ports 1020 may be one or more serial and/or parallel communication ports that provide communication between additional peripheral devices, which may be coupled to the computer system 1000.

The computer system 1000 may include a variety of system architectures, and various components of the computer system 1000 may be rearranged. For example, the cache 1004 may be on-chip with processor 1002. Alternatively, the cache 1004 and the processor 1002 may be packed together as a “processor module”, with processor 1002 being referred to as the “processor core”. Furthermore, certain embodiments of the invention may neither require nor include all of the above components. For example, peripheral devices coupled to the standard I/O bus 1008 may couple to the high performance I/O bus 1006. In addition, in some embodiments, only a single bus may exist, with the components of the computer system 1000 being coupled to the single bus. Moreover, the computer system 1000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1000 that, when read and executed by one or more processors, cause the computer system 1000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1002. Initially, the series of instructions may be stored on a storage device, such as the mass storage 1018. However, the series of instructions can be stored on any suitable computer readable storage medium. Furthermore, the series of instructions need not be stored locally, and could be received from a remote storage device, such as a server on a network, via the network interface 1016. The instructions are copied from the storage device, such as the mass storage 1018, into the system memory 1014 and then accessed and executed by the processor 1002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
identifying, by a computing system, a source content item for which related content is to be provided;
selecting, by the computing system, a set of candidate content items associated with the source content item;
ranking, by the computing system, the set of candidate content items based, at least in part, on a set of engagement signals associated with the set of candidate content items; and
providing, by the computing system, a subset of highest ranked candidate content items out of the set of candidate content items as the related content for the source content item.

2. The computer-implemented method of claim 1, wherein the selecting of the set of candidate content items further comprises:
selecting each candidate content item in the set of candidate content items based on content selection criteria, wherein the content selection criteria is associated with at least one of a topic similarity level between a respective candidate content item in the set of candidate content items and the source content item, a creator identity similarity level between the respective candidate content item and the source content item, a domain similarity level between the respective candidate content item and the source content item, or a collaborative filtering process for the respective candidate content item and the source content item.

3. The computer-implemented method of claim 2, further comprising:
ranking the set of candidate content items based, at least in part, on information associated with the content selection criteria.

4. The computer-implemented method of claim 1, further comprising:
ranking the set of candidate content items based, at least in part, on at least one of a domain quality level of a respective candidate content item in the set of candidate content items, a content originality level of the respective candidate content item, a content similarity level of the respective candidate content item relative to the set of candidate content items, or a personalization metric of the respective candidate content item.

5. The computer-implemented method of claim 1, wherein the ranking of the set of candidate content items based, at least in part, on the set of engagement signals further comprises:
calculating a score for each respective candidate content item in the set of candidate content items based on one or more engagement signals, in the set of engagement signals, that are associated with the respective candidate content item; and
sorting respective candidate content items based on scores for the respective candidate content items.

6. The computer-implemented method of claim 5, wherein the one or more engagement signals indicates at least one of a click-through rate (CTR), a share amount, a like amount, or a hide amount.

7. The computer-implemented method of claim 6, wherein the score for the respective candidate content item is higher when at least one of the click-through rate (CTR), the share amount, or the like amount is higher, and wherein the score for the respective candidate content item is lower when the hide amount is higher.

8. The computer-implemented method of claim 6, wherein the one or more engagement signals are assessed in real-time, wherein the calculating of the score for the respective candidate content item is performed in real-time, and wherein the sorting of the respective candidate content items is performed in real-time.

9. The computer-implemented method of claim 1, further comprising:
detecting a trigger to initiate the providing of the subset, wherein the trigger is detected based on a user interaction with respect to the source content item.

10. The computer-implemented method of claim 9, wherein the user interaction with respect to the source content item is associated with at least one of a click, a tap, a loading command, a share, or a like.

11. The computer-implemented method of claim 1, wherein the identifying of the source content item further comprises:
detecting that the source content item has been posted; and
determining that the source content item is separate from other content items previously posted.

12. The computer-implemented method of claim 1, wherein the source content item is associated with a first domain, and wherein at least one content item in the subset of highest ranked candidate content items is associated with a second domain.

13. The computer-implemented method of claim 1, wherein the source content item is associated with a first content type, wherein at least one content item in the subset of highest ranked candidate content items is associated with a second content type, and wherein each of the first content type and second content type is associated with at least one of an image content type, an audio content type, a video content type, a content link type, or an article content type.

14. The computer-implemented method of claim 1, wherein the source content item is identified from at least one of a social networking system, a third-party application, a third-party online resource, or a third-party service, and wherein the subset of highest ranked candidate content items is provided by or to the at least one of the social networking system, the third-party application, the third-party online resource, or the third-party service.

15. The computer-implemented method of claim 1, wherein the subset of highest ranked candidate content items is provided in at least one of a vertical arrangement below the source content item or a horizontal arrangement below the source content item.

16. The computer-implemented method of claim 15, wherein the subset of highest ranked candidate content items is vertically scrollable when provided in the vertical arrangement, and wherein the subset of highest ranked candidate content items is horizontally scrollable when provided in the horizontal arrangement.

17. The computer-implemented method of claim 1, wherein the source content item includes a first video displayed at a first position, wherein at least one content item in the subset of highest ranked candidate content items includes a second video displayed at a second position, and wherein the second video is played in the first position in place of the first video when a user command to play the second video is received.

18. The computer-implemented method of claim 17, further comprising:
providing additional related content for the second video.

19. A system comprising:
at least one processor; and
a memory storing instructions that, when executed by the at least one processor, cause the system to perform:
identifying a source content item for which related content is to be provided;
selecting a set of candidate content items associated with the source content item;
ranking the set of candidate content items based, at least in part, on a set of engagement signals associated with the set of candidate content items; and
providing a subset of highest ranked candidate content items out of the set of candidate content items as the related content for the source content item.

20. A non-transitory computer-readable storage medium including instructions that, when executed by at least one processor of a computing system, cause the computing system to perform:
identifying a source content item for which related content is to be provided;
selecting a set of candidate content items associated with the source content item;
ranking the set of candidate content items based, at least in part, on a set of engagement signals associated with the set of candidate content items; and
providing a subset of highest ranked candidate content items out of the set of candidate content items as the related content for the source content item.
